(19) United States
(12) Patent Application Publication
(10) Pub. No.: US 2008/0220142 A1
(43) Pub. Date: Sep. 11, 2008

(54) Process for Producing an Aerated Granulated Foodstuff, and Corresponding Product and Device

(75) Inventor: Sergio Mansuino, Mondovi (Cuneo) (IT)

Correspondence Address: ROTHWELL, FIGG, ERNST & MANBECK, P.C., 1425 K STREET, N.W., SUITE 800, WASHINGTON, DC, 20005, US

(73) Assignee: SOREMARTEC S.A., Arlon-Schoppach (BE)

(21) Appl. No.: 11/915,768

(22) PCT Filed: May 31, 2006
(86) PCT No.: PCT/IB06/01482

§ 371 Date: Nov. 28, 2007

(30) Foreign Application Priority Data
Jun. 7, 2005 (IT) TO2005A000389

(51) Int. Cl. A23P 1/10; A23L 1/00; A23G 3/12; A47J 43/04

(52) U.S. Cl. 426/568; 426/443; 426/564; 425/436 R; 425/218; 425/440; 99/427

(57) ABSTRACT

In order to make a granulated substance (G) of an aerated foodstuff, such as granulated meringue, said substance having an outer surface that appears continuous to the naked eye, an alveolar (18) structure (12) is provided, and a liquid precursor of the aerated foodstuff (for example, the so-called “meringue foamed mixture” in the case of meringue) is introduced (20, 22) into the cavities (18) of the structure. Consolidation of the precursor introduced into the cavities (18), obtained, for example, via heating (24), leads to the formation, in the aforesaid cavities (18), of respective particles of granulate (G), which are finally extracted from the cavities (18), typically exploiting the deformation of the material constituting the alveolar structure.

### FIELD OF THE INVENTION

The present invention relates to the production of a granulated foodstuff.

The invention has been developed with specific attention paid to the preparation of granulate (i.e., according to the current meaning of the term, small granules whose maximum dimensions measure a few units of millimiters) of aerated, or foamed, foodstuff and hence foodstuff with a low specific weight. A typical example of such a foodstuff is represented by the product commonly referred to as “meringue”.

### DESCRIPTION OF THE RELATED ART

The term “meringue” usually indicates a markedly aerated mass obtained by consolidating, via cooking, a liquid/foamed mass (constituting a “precursor” of the end product) formed by a mixture of water, egg white and sugar, usually with the addition of aromas. This liquid precursor is commonly referred to in the food sector as “meringue foamed mixture”.

One of the traditional techniques for producing meringue granulate envisages that the meringue foamed mixture is poured on a support, constituted usually by a motor-driven conveyor belt, so as to form on the pouring support a strip or rib of a certain thickness (roughly resembling stick bread). The filiform mass thus poured is fed into an oven so as to obtain cooking thereof, with consequent consolidation of the meringue. The mass of consolidated meringue thus obtained is finally sent on to a mincing station, which usually comprises rotating bodies, such as counter-rotating circular blades. The mass of consolidated meringue is thus minced, giving rise to a granulate constituted by particles that have the appearance schematically illustrated in FIG. 1.

The above product is basically in the form of granules with a markedly irregular appearance and characterized by a high surface porosity with “open-pore” formations caused by the mincing process.

When one operates according to the prior art described here, the mean grain size of the granulate thus obtained (usually in the region of 1-4 and, preferably 1-3 mm) can be adjusted by acting on the station in which mincing of the solid body is carried out, which leads to the formation of the granulate. Broadly speaking, the reduction or increase of the mean grain size is obtained with appropriate adjustments of the grinding system (by increasing or decreasing the distance between the rotating blades).

This process for the production of granulate presents a basic drawback represented by the fact that the mincing operation described previously produces, in addition to granulate that can be employed for normal uses, a considerable amount (estimated at approximately 30 wt % of the product subjected to mincing) of meringue “flour”. The flour in question is a very fine powder, which is in effect unusable for normal uses of the granulate and hence is such as to constitute to all effects a reject.

Another drawback is represented by the fact that the granulate obtained has a considerable surface porosity (see once again FIG. 1) and a consequent considerable friability, which is a cause of production of powder or flour due to rubbing during transportation and during the subsequent processing steps. Said effect leads to considerable drawbacks on the production lines, which call for frequent stoppages for cleaning.

A further drawback is represented by the fact that the grain size of the granulate obtained with the traditional process described is extremely variable. In practice, the statistical distribution of the radial dimensions of the particles forming the granulate has an approximately Gaussian distribution, with a rather high variance with respect to the mean value.

It will moreover be appreciated that the techniques commonly adopted for making granulate of compact foodstuffs are not applicable to the production of granulated meringue (and in general of granulate of markedly aerated foodstuffs). Consider, by way of reference, the granulate obtained starting from nuts and the like (for example, granulate of hazelnuts or almonds obtained by mincing the corresponding toasted nuts, or grated coconut), or again certain noodles for soup or broth, or else, khus-khus. In all these cases, the starting material is a sufficiently compact material, capable of withstanding, without any deterioration, mechanical stresses of a certain intensity such as the ones that may arise during mincing or shredding operations, grating, or extrusion and cutting, or during processes to produce uniform granules by compression-moulding as described e.g. in PATENT ABSTRACTS OF JAPAN, vol. 006, no.098 (C-106), 8 Jun. 1982 (1982-06-08)-&JP 57 027123 A (KANEBO LTD).

Meringue is, instead, an extremely brittle material that can be reduced to powder as a result of even a modest mechanical stress of this type. Equally delicate and sensitive to external stresses is the precursor used for making the meringue, i.e., the meringue foamed mixture (see, in this connection, EP-A-0 539 646). Consequently, even though, in principle, it might be possible to consider producing a granulate, for example, via extrusion, the resultant granulate would be different also structurally from the product sought.

As for the rest, the prior art includes processes for producing by moulding biscuits comprised of meringue or similar substances (see, for instance, FR-A-2 589 680, FR-A-2 690 313) as well as processes for pouring into moulds aerated foodstuffs (see, for instance, U.S. Pat. No. 4,637,788, U.S. Pat. No. 4,262,029 or US-A-2004/0234660). Similarly known are techniques for producing shaped bodies by extruding and compacting powders (see, for instance, U.S. Pat. No. 4,120,627 o U.S. Pat. No. 4,431,394) as well as techniques for producing various foodstuffs by depositing a substance over a belt within the framework of a continuous process (see, for instance, US-A-2004/096557, FR-A-2 738 992 o US-A-2003/091715).

### OBJECT AND SUMMARY OF THE INVENTION

From the foregoing it is evident that the need is felt of having available solutions that will enable making an aerated granulated—i.e. a minute particulated—foodstuff (such as, for example, meringue) that will present the following characteristics:
the particles of granulate should be free from structural alterations that might have an adverse effect on the characteristics of the product;
the grain size should be identified in a sufficiently precise way, hence without giving rise to a high variance of the grain size with respect to the mean value; and
the granulate may be produced with a minimal amount, virtually zero, of processing waste and is suitable for being handled, without the risk of pulverization during the processes subsequent to the ones for its production.

The object of the present invention is to provide a device that is altogether able to meet the above needs.

According to the present invention, that object is achieved thanks to a process having the characteristics referred to in the claims that follow. The invention also regards the granulate that can be obtained with said process, as well as a corresponding device.

The claims form an integral part of the technical disclosure provided herein in relation to the invention. To sum up as briefly as possible, the invention mainly regards the solution that envisages making granulated meringue (or granulate of any other aerated foodstuff) using any process that contemplates the dosage of the precursor of the end product in a mould.

The invention then regards, in general terms, the granulated foodstuff having the characteristics described herein namely a granulated foodstuff in the form of moulded granules. It will be appreciated that such a choice goes completely against the teaching of the prior art and common sense: in fact it appears far from logical and expedite to produce a granulated foodstuff, namely a minute granular material (whose granules have dimensions that measure, at most, a few units of millimetre) by individually moulding each and every granule. Moreover, in a thoroughly surprising and unexpected manner, such a choice leads to an improvement in the intrinsic characteristics of the granulated foodstuff, by giving rise to a completely new product in comparison with any granulated foodstuff as obtained by the conventional techniques described in the introductory portion of this description. Specifically, the individual granules of the granulated material described herein are individual particles that have, as far as possible, a compact outer surface, which we shall define as a “closed-pore” surface, i.e., a surface structure that appears continuous to the naked eye from a normal viewing distance (approximately 30 cm).

### BRIEF DESCRIPTION OF THE DRAWINGS

The invention will now be described, purely by way of non-limiting example, with reference to the annexed figures of drawing, in which:

FIG. 1, to which reference has already been made previously, illustrates the appearance of a particle or granule of granulated meringue obtained according to the prior art;

FIG. 2 illustrates the appearance of some particles or granules of meringue made according to the solution described herein;

FIG. 3 is a general perspective view of a device that can be used for the production of granulated meringue;

FIG. 4 illustrates, in greater detail, the characteristics of one of the elements comprised in the device of FIG. 3;

FIG. 5 is a cross-sectional view according to the line V-V of FIG. 4; and

FIG. 6 is a cross-sectional view according to the line VI-VI of FIG. 3.

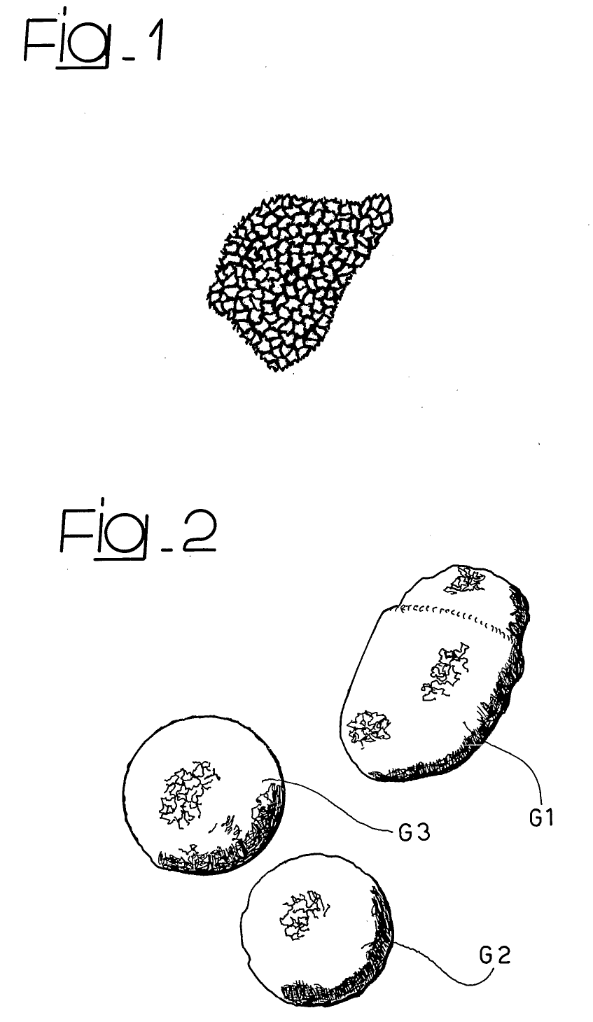

Description of a preferred exemplary embodiment of the invention In FIG. 3 of the attached figures of drawing, the reference number 10 designates, as a whole, a device that can be used for the production of granulated meringue (or, in general, granulate of any other aerated foodstuff that can be consolidated).

It is once more recalled that, according to the current meaning as used herein, the term granulated foodstuff material indicates a particulate material comprised of granules whose maximum dimensions have measures up to a few units of millimetre.

The device 10 comprises a belt 12 run in an endless loop over a set of return rollers designated as a whole by 14, at least one of which is driven in rotation by a motor, which is not shown in the drawings but is of a known type, the aim being to move the belt 12 in such a way that its top branch, designated by 12a, advances in the direction indicated by the arrow A (i.e., towards the observer and from right to left as viewed in FIG. 3).

Motor-driven endless belts of the type described are widely used in the foodstuff industry, in particular for making belt conveyors in automatic packaging lines for foodstuffs, such as confectionery products.

Preferentially, for reasons that will emerge more clearly from what follows, in a position corresponding to the end downstream with respect to the direction of movement described (see, in particular, FIG. 6), the top branch 12a of the belt 12 is run, instead of over a return idler, over a fixed return formation 16 of the type commonly referred to as “feather” in the sector of motor-driven conveyors. Generally, the use of a feather such as the feather 16, instead of a return roller, is envisaged in all those cases in which it is desired to impose upon the belt 12 a particularly small radius of winding of the belt 12 (for example, in the region of a centimetre or less), which is far from readily compatible with the need to provide a roller that is able to rotate about a respective axis, maintaining a sufficient degree of rigidity.

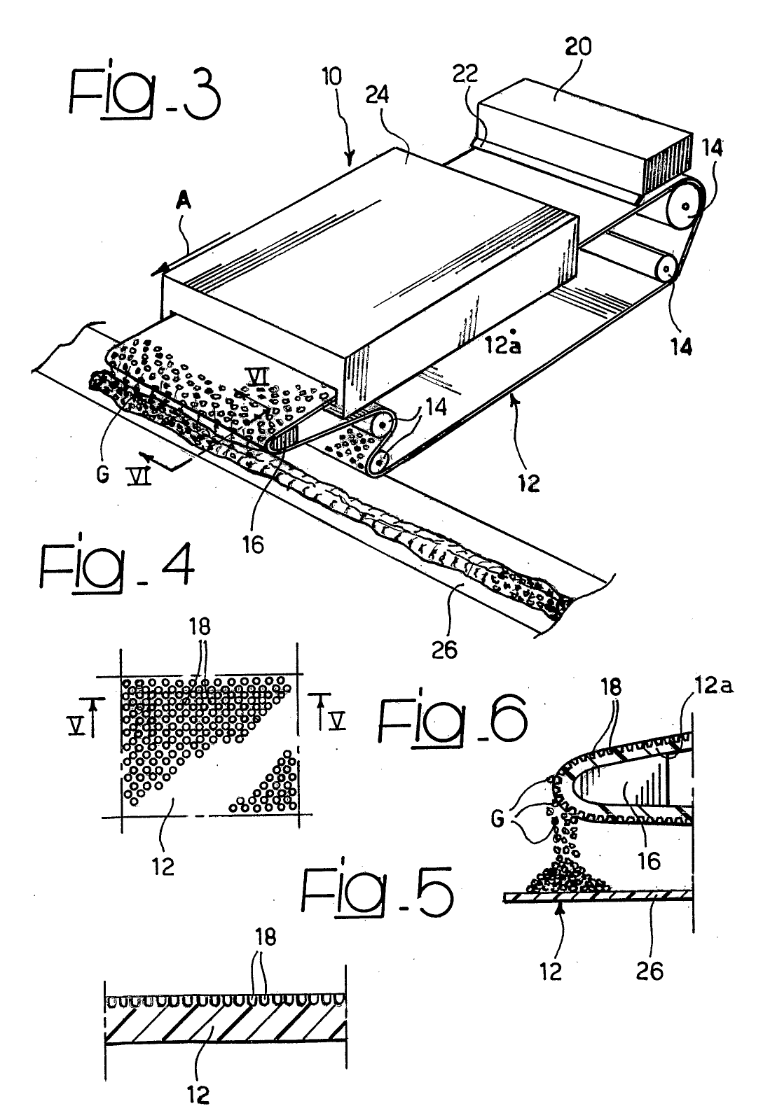

As will be better appreciated from the views of FIGS. 4 and 5, an important characteristic of the belt 12 is represented by the fact that it has on a surface that is external with respect to the winding path (and hence on the top surface of the branch 12a) a surface engraving with cavities 18. Said engraving (referred to in what follows also as “alveolar surface”) is constituted by an array of small cavities 18, which, as will emerge more clearly hereinafter, are designed to form respective granules of said granulate G. This is preferentially a dense and regular array of cavities 18, which gives rise to an alveolar surface that extends in a continuous way over the surface of the belt 12.

The alveolar surface in question can be produced via an operation of moulding when the belt 12 itself is formed from a plastic material. That plastic material may typically be constituted by a silicone rubber of the type approved for use in contact with foodstuffs and suitable for withstanding the temperatures necessary for cooking the product.

The cavities 18 can be made with different shapes, for example hemispherical, conical, that of a truncated cone, pyramidal, or prismatic, and may have dimensions in the region of a millimetre, meaning thereby diametral dimensions of the cavities (which can be detected both in plan view and in depth with respect to the development of the belt 12) that can range from a few tenths of a millimetre (for example, 0.3-0.4 mm) up to 2-3 mm, generally up to a value lower than 4 mm.

These values (which, as will be understood better from what follows, in effect identify the grain size of the granulate obtained) are provided herein by way of example in relation to some typical contexts of application. These values must not hence be interpreted in a sense in any way limiting the scope of the invention, being it naturally understood that one here refers to a granulated material that is rather minute, As explained previously, by granulated foodstuff material a granular material is meant here which is comprised of moulded particles or granules whose maximum dimensions can be measured as a few units of millimetre. Typically, these particles have dimensions lower than 4 mm and/or an average grain size between 1 and 4 mm, preferably between 1 and 3 mm.

The reference number 20 designates a feed station (usually located in a position generically upstream within the development of the top branch 12a of the belt 12), where a liquid mass of meringue foamed mixture is poured/spread within the cavities 18, such meringue foamed mixture being formed by a mixture of water, egg white, and sugar, usually with the addition of aromas, which is then subjected to whipping so as to englobe therein a certain amount of air to form the “precursor” of the granulated meringue.

For the purposes of practical implementation, the feed station 20 roughly resembles the pourer for meringue foamed mixture described in detail in the document EP-A-0 539 646 to which reference has already been made previously. However, whereas the pourer described in the document EP-A-0 539 646 is configured so as to pour isolated masses of meringue foamed mixture with dimensions typically of one centimetre or more, the station 20 described herein has the function of introducing the aforesaid precursor into the fine network of cavities constituted by the mesh of cavities 18.

In this connection, is it will be noted that, even though it is not necessary to meet specific functional requirements in this connection, the aforesaid mesh of cavities is usually made in the form of a regular, rather dense network so as to maximize the ratio between the areas of cavities 18 and the “full” areas that separate said cavities from one another.

The pourer station 20 comprises, then, downstream of the point of pouring proper, a device 22, the function of which is basically that of obtaining penetration and settling of the aforesaid liquid/foamed precursor (meringue foamed mixture) within the cavities 18, keeping the surface of the belt 12 clean in its plane parts which connect the alveolar parts.

In practice, in the area downstream of the pouring station 20, the top branch 12a of the belt 12 presents the surface engraving constituted by the cavities 18, which is filled with the liquid/foamed precursor of the granulate, poured into the cavities 18, whilst any excess residue on the top surface of envelope of the belt 12 is removed by the action of the element 22.

In the above conditions, the top branch 12a of the belt advances towards a heating station 24, the function of which is to bring about consolidation of the liquid mass previously poured into the cavities 18.

In the case of the meringue foamed mixture, the aforesaid action of consolidation is obtained via heating and cooking.

In traditional plants for the production of granulated meringue, said action of consolidation envisages carrying out cooking proper as a result of the passage through an oven, with a stay therein for a period of several minutes.

In the case of the device 10 illustrated herein, the consolidation station 24 can be constituted simply by a heating unit, for example, a hot-air unit, a unit heated by electrical resistors, an IR-radiation heating unit, a heating unit that uses microwave elements, or a radiofrequency heating unit, which produces an action of consolidation of the masses of aerated foodstuff located in the cavities 18, which takes place in an extremely short time interval (in the region of a few minutes at the most).

It will be appreciated that this result (which is beneficial both in terms of rapidity of the production process and on account of the possibility of reducing the overall dimensions of the device) is linked to the fact that the amount of liquid/foamed precursor that is found in the individual cavities 18 has an extremely small thermal capacity and is thus capable of heating up and consolidating (in practice “cooking”) in an extremely short time.

Downstream of the heating station 24, the belt 12 advances in conditions substantially similar to the ones described previously, with the important difference represented by the fact that now (i.e., downstream of the heating station 24) within each of the cavities 18 there is a particle of consolidated, i.e., “cooked” meringue, usually slightly puffed up as compared to the “wet” dimensions.

When, once having arrived in a position corresponding to the end downstream of the top branch 12a, the belt 12 runs over the feather 16, the elastomer material that constitutes it is deformed, in general bringing about a certain stretching of the mouth part of each of the cavities 18 in the direction of advance of the belt 12. The feather 16, together with the portion of belt 12 that is run thereover, constitutes in effect the unloading station of the device 10, i.e., the station in which the deformation of the individual cavities 18 produces, with the aid of a device generally constituted by a brush, expulsion from the cavities 18 themselves of the particles of meringue that are located therein.

The granulate G thus produced can then be collected by being dropped on an underlying conveyor, designated by 26, and fed via that conveyor either to a storage plant or directly to a processing station that makes use thereof (for instance, for forming layers of garnishing on praline or similar foodstuffs).

The individual particles of granulate G thus obtained have the appreciable characteristics that may be noted from FIG. 2, wherein the reference G1 indicates a granule observed in perspective view, while the references G2 and G3 indicate two other granules observed “end-on”. A significant feature of the granulated material described herein lies in that it is comprised of particles or granules that, being moulded, i.e. obtained by moulding (for instance with the method described previously), have a rather regular shape (which is complementary to the shape of the cavities where the granules were formed by moulding) and an outer surface which (both in the part that has been exposed to the walls of the cavities 18 and in the part remaining exposed through the top opening of the cavities 18 themselves) is substantially continuous, i.e., it is a substantially “closed-pore” surface, as mentioned previously, that appears “continuous” to the naked eye.

Additionally, each particle of granulate G1, G2, G3 is obtained by moulding, by being poured into each of the individual cavities 18. Even though in the course of cooking in the station 24 the meringue foamed mixture must be subjected to a certain “leavening” or puffing-up, each particle of the granulate G has radial dimensions that are strictly dictated by the dimensions of the cavities 18. Consequently, the grain size of the granulate G that can be obtained with the process described herein can be regulated in a very precise way. That grain size has a statistical distribution around its mean value which has a considerably smaller variance (by at least one order of magnitude) with respect to the homologous parameter of the granulated meringue obtained with traditional techniques.

This makes possible the production of granulate with a grain size that is exactly defined and rendered uniform around a well-defined mean value.

At the level of production plants, it is on the other hand possible to use, in parallel, devices 10 equipped with belts 12 having cavities 18 of different dimensions, or else to get the same device 10, equipped with belts 12 provided with cavities 18 of different dimensions, to work on successive lots. Furthermore, it is also possible to envisage, within the same belt 12, the presence of cavities 18 of different dimensions.

In this way, it is possible to produce “mixed” granulate in which there coexist given quantities (possibly in precisely determined percentages) of granules or particles belonging to different granulometric classes, well-defined around the respective mean values.

Tests conducted by the present applicant have shown that the use of “mixed” granulate of the type described above is preferable in all those applications in which it is desired to bestow upon the end product an appearance that is as much as possible “home-made”.

It will be appreciated then that the solution described herein enables production of a granulate in which the individual particles are moulded granules (i.e. granules obtained by moulding) that have as far as possible a compact, i.e., “closed-pore”, outer surface. Additionally, these particles of granulate are free from structural alterations such as to have an adverse effect on the characteristics of the product. The grain size of the granulate is identified in a precise way, without giving rise to a high variance of the grain size with respect to the mean value. Furthermore, the granulate is produced with a minimum amount, virtually zero, of rejects and can be handled without any risks of powdering or any contamination of the production lines.

Of course, without prejudice to the principle of the invention, the details of implementation and the embodiments may vary, even to a marked extent, with respect to what is described and illustrated herein purely by non-limiting example, without thereby departing from the scope of the invention, as defined by the annexed claims.

1. A process for making granulate of an aerated foodstuff, characterized in that it comprises the steps of:
providing a mould having an alveolar structure;
introducing into the alveolar structure of said mould a precursor of said aerated foodstuff;
bringing about consolidation of said precursor introduced into said mould so as to form in said alveolar structure respective particles of said granulate; and
removing from said mould said particles of granulate.

2. The process according to claim 1, characterized in that it uses, as said precursor, a liquid, pasty, or foamed precursor.

3. The process according to claim 1, characterized in that said step of introduction comprises the operations of:
pouring said precursor onto said alveolar structure; and
removing the excess precursor from said alveolar structure.

4. The process according to claim 1, characterized in that said step of consolidation involves the application of heat to said precursor.

5. The process according to claim 1, characterized in that said step of removal comprises the operation of deforming said alveolar structure, producing expulsion of said particles of granulate.

6. The process according to claim 1, characterized in that it comprises the step of providing said alveolar structure in a body made of deformable elastomer material.

7. The process according to claim 1, characterized in that it comprises the step of providing said alveolar structure in a body that moves during the process.

8. The process according to claim 1, characterized in that said precursor is a meringue precursor, so that said granulate is granulated meringue.

9. The process according to claim 1, characterized in that it comprises the step of providing said alveolar structure as an array of cavities that are to form respective granules of said granulate.

10. The process according to claim 1, characterized in that the cavities in the alveolar structure of said mould have dimensions between a few tenths of millimetre and a few millimetres.

11. The process according to claim 1, characterized in that the cavities in the alveolar structure of said mould have dimensions between 0.3-0.4 millimetres and 2-3 millimetres.

12. The process according to claim 1, characterized in that the cavities in the alveolar structure of said mould have dimensions lower than 4 millimetres.

13. A granulate of aerated foodstuff, obtained with the process according to claim 1.

14. A granulate of aerated foodstuff, obtainable with the process according to claim 1.

15. A granulate of aerated foodstuff, said granulate being substantially constituted by moulded particles (granules).

16. The granulate according to claim 15, characterized in that said moulded particles have an internal alveolar structure and an outer surface that appears continuous to the naked eye.

17. The granulate according to claim 15, characterized in that said moulded particles have maximum dimensions of a few millimetre units.

18. The granulate according to claim 15, characterized in that said moulded particles have dimensions lower than 4 millimetres.

19. The granulate according to claim 15, characterized in that said moulded particles have an average grain size from 1 to 4 millimetres, preferably from 1 to 3 millimetres.

20. The granulate according to claim 15, characterized in that said granulate is granulated meringue.

21. A device for making granulate of an aerated foodstuff, characterized in that it comprises:
a mould having an alveolar structure;
a feed station for introducing a precursor of said aerated foodstuff into the alveolar structure of said mould;
a consolidation station for bringing about consolidation of said precursor introduced into said mould so as to form, in said alveolar structure respective particles of said granulate; and
a unloading station for removing said particles of granulate from said mould.

22. The device according to claim 21, characterized in that said feed station comprises a pourer for pouring onto said alveolar structure a precursor of said aerated foodstuff.

23. The device according to claim 21, characterized in that said feed station comprises a removal element for removing the excess precursor from said alveolar structure.

24. The device according to claim 21, characterized in that said consolidation station comprises a cooking station for bringing about consolidation of said precursor introduced into said mould via application of heat.

25. The device according to claim 24, characterized in that said cooking station is chosen in the group constituted by hot-air cooking stations, electrical-resistance cooking stations, ultrasound cooking stations, radiofrequency cooking stations, and microwave cooking stations.

26. The device according to claim 21, characterized in that said one unloading station comprises an reaction element (16) on which said alveolar structure is deformed, with consequent expulsion of said particles of granulate.

27. The device according to claim 21, characterized in that said alveolar structure is provided with a body made of deformable elastomer material.

28. The device according to claim 21, characterized in that it comprises a motor element for the advance of the mould with said alveolar structure.

29. The device according to claim 21, characterized in that said alveolar structure is an alveolar surface of a belt body run in an endless loop and mobile over roller or transmission elements, at least one of said transmission elements being located in a position corresponding to said unloading station for producing, thanks to the deformation of said belt body that is run thereon, deformation of said alveolar structure and expulsion of said particles of granulate.

30. The device according to claim 29, characterized in that said at least one of said transmission elements, located in a position corresponding to said unloading station, is a so-called feather, over which said belt body is run.

31. The device according to claim 21, characterized in that said feed station comprises a pourer for pouring into said mould a liquid, foamed or pasty precursor.

32. The device according to claim 21, characterized in that said alveolar structure is constituted by a an array of cavities that are to form respective granules of said granulate.

33. The device according to claim 21, characterized in that the cavities in the alveolar structure of said mould have dimensions between a few tenths of millimetre and a few millimetres.

34. The device according to claim 21, characterized in that the cavities in the alveolar structure of said mould have dimensions between 0.3-0.4 millimetres and 2-3 mm.

35. The device according to claim 21, characterized in that the cavities in the alveolar structure of said mould have dimensions lower than 4 millimetres.
